(19) United States
(12) Patent Application Publication
(10) Pub. No.: US 2015/0196000 A1
(43) Pub. Date: Jul. 16, 2015

(54) RETAINING PLATE FOR SPRINKLER TRIPOD

(71) Applicant: Tzu-Lin HUANG, Xianxi Township (TW)

(72) Inventor: Tzu-Lin HUANG, Xianxi Township (TW)

(21) Appl. No.: 14/152,422

(22) Filed: Jan. 10, 2014

(51) Int. Cl. A01G 25/00; F16M 11/24

(52) U.S. Cl. CPC A01G 25/00; F16M 11/245

(57) ABSTRACT

A retaining plate applied to a sprinkler tripod is set onto a water manifold of the sprinkler tripod in a preset plate pattern, and located at an interior of the foot stands of the sprinkler tripod. Said retaining plate has a sleeving portion, arranged at a preset location of the retaining plate. With the sleeving portion, said retaining plate could be set on the water manifold to rotate by taking the water manifold as its axle center. Multiple abutting portions are formed onto periphery of the retaining plate. When the foot stands of the sprinkler tripod are in expanded state, the retaining plate is rotated such that the abutting portions are mated with the foot stands, and the foot stands can be abutted onto the abutting portions for secure support. Multiple openings are set at one side of the abutting portions of the retaining plate.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a retaining plate, and more particularly to an innovative one which is designed for a sprinkler tripod.

2. Description of Related Art Including Information Disclosed Under 37 CFR 1.97 and 37 CFR 1.98

If extensive sprinkling and irrigation is required in garden planting, sprinklers (such as percussive sprinklers, etc.) are generally used. Through circulatory or reciprocating motions, these sprinklers could be adopted to ease the burden in traditional manual sprinkling or irrigation.

To facilitate erection of a sprinkler around a flower nursery or the plants, a tripod is generally set below the sprinkler as a support for easier installation and sprinkling. However, the conventional tripod structure is often designed into a radial foot stand composed of interconnected rods, so as to meet the utility requirements of folding or unfolding via the linking relationship among the rods. Nonetheless, after a period of service time for such conventional tripod structures, loosening may occur at the pin joints of rods, and the tripod cannot be kept stable but will easily sway when the tripod is in an unfolded erection state. In addition, no bracing structure is set as a support inside the tripod. Therefore, during sprinkling process, the tripod is easily retracted inwards, leading to falling down or malfunction of the sprinkle due to vibration or shaking. Besides, the relative position of rods cannot be limited when the conventional tripod is folded, so it is easy to affect the visual effect or overall appearance due to disorderly arrangement of the rods.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the unique design of the present invention wherein the “retaining plate for a sprinkler tripod” is operated based on the mating relationship of the abutting portions/openings of the retaining plate and the foot stands of the sprinkler tripod, the foot stands in expanded state could be securely supported. So, during the sprinkling process of the sprinkler, this could prevent inward retracting, inclination or even falling down arising from vibration or shaking of the foot stands. On the other hand, as the foot stands in retracted state could be inserted into the openings, the foot stands could swing uniformly and orderly with good visual effect and better convenience, thus improving greatly the robustness of the sprinkler tripod in expanded state and the aesthetic effect and convenience in retracted state as well as the actual benefits.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the retaining plate of the present invention.

FIG. 2 is a perspective view of another preferred embodiment of the retaining plate of the present invention.

FIG. 3 is a structural perspective view of the present invention wherein the sprinkler tripod and retaining plate are incorporated.

FIG. 4 is a perspective view showing the operating state of the present invention.

FIG. 5 is a perspective view showing the operating state of the present invention.

FIG. 6 is an overall plane view of the present invention wherein the sprinkler tripod is fitted with sprinklers.

FIG. 7 is a schematic view of the present invention showing the adjustment state of the adjustable spacer.

FIG. 8 is a structural view of the present invention wherein the retaining plate could limit the foot stands.

FIG. 9 is a structural view of another preferred embodiment of the present invention wherein the retaining plate could limit the foot stands.

### DETAILED DESCRIPTION OF THE INVENTION

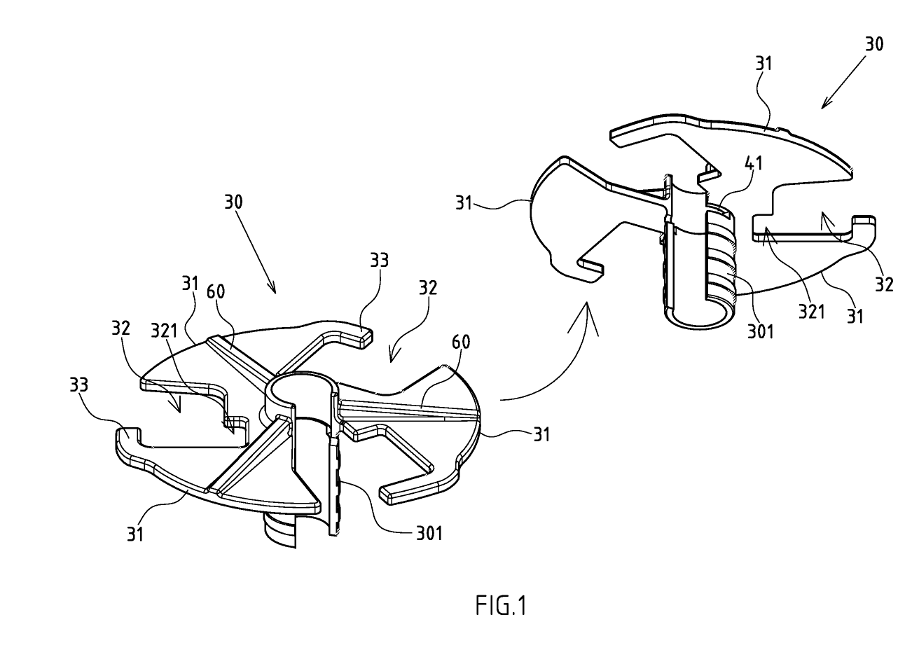

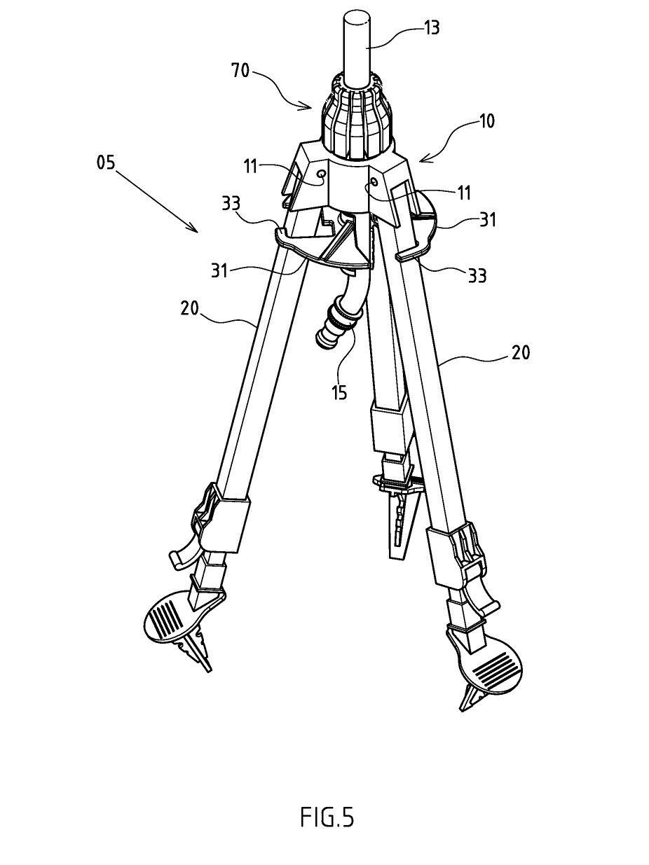

FIGS. 1-6 depict preferred embodiments of a retaining plate of the present invention for a sprinkler tripod, which, however, are provided for only explanatory objective for patent claims. Said retaining plate 30 is set onto a water manifold 13 of the sprinkler tripod 05 in a preset plate pattern, and located at interior of the foot stands 20 of the sprinkler tripod 05. The structure of the sprinkler tripod 05 and the retaining plate 30 is described as follows

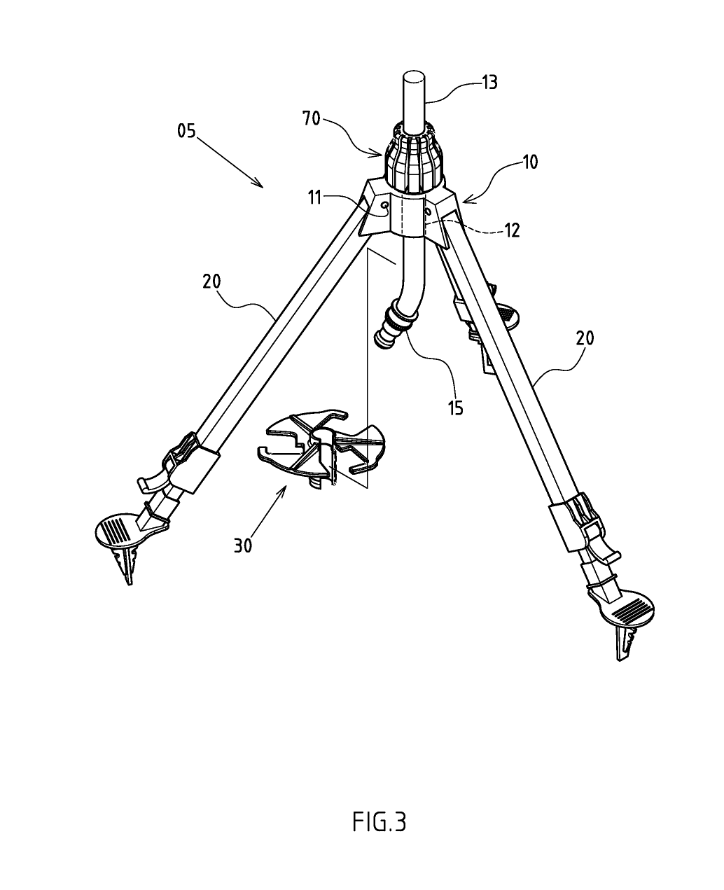

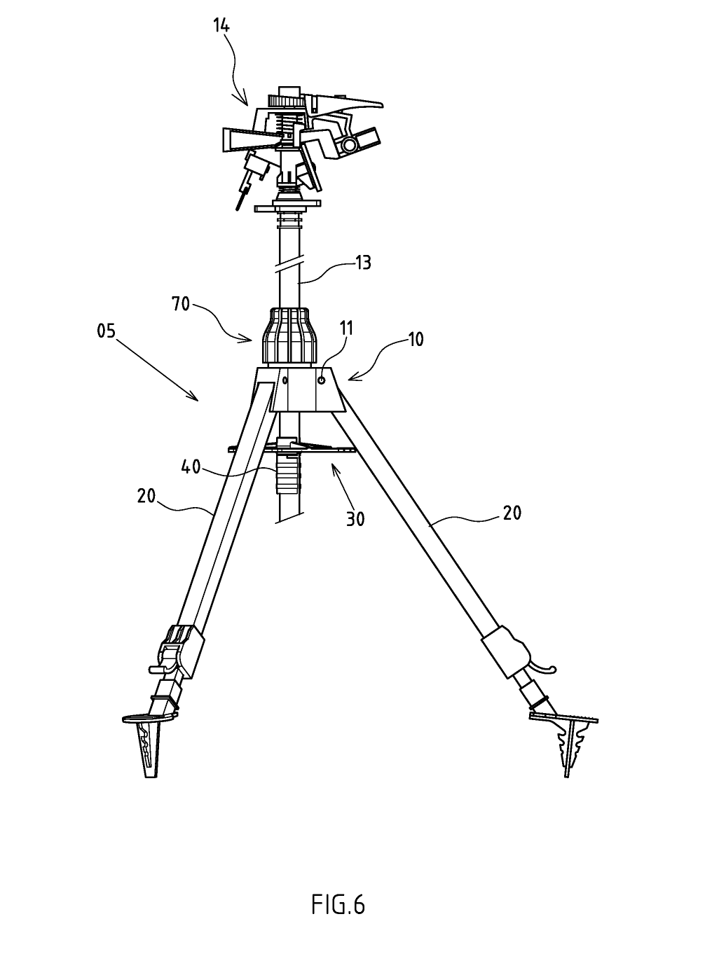

The sprinkler tripod 05 comprises a pedestal 10, set into a predefined pattern of actual model. Multiple pin joints 11 are arranged at interval on the circumferential sections of the pedestal 10; and a through hole 12 (only marked in FIG. 3) is vertically set at the center of the pedestal 10 for insertion of a water manifold 13. A sprinkler 14 (only marked in FIG. 6, optionally a swinging sprinkler) is set above the water manifold 13, and a mating portion 15 is set below the water manifold 13, such that incoming water of a water supply (e.g.: water tube) could flow through the water manifold 13 for sprinkling via the sprinkler 14.

Multiple foot stands 20 are provided. One end of which is separately pivoted at the pin joint 11 of the pedestal 10, such that the foot stands 20 could swing by taking the pin joint 11 as axle center in an expandable or retractable state.

A retaining plate 30 is set onto the water manifold 13 in a preset plate pattern below the pedestal 10. Said retaining plate 30 must be located at interior of the foot stands 20.

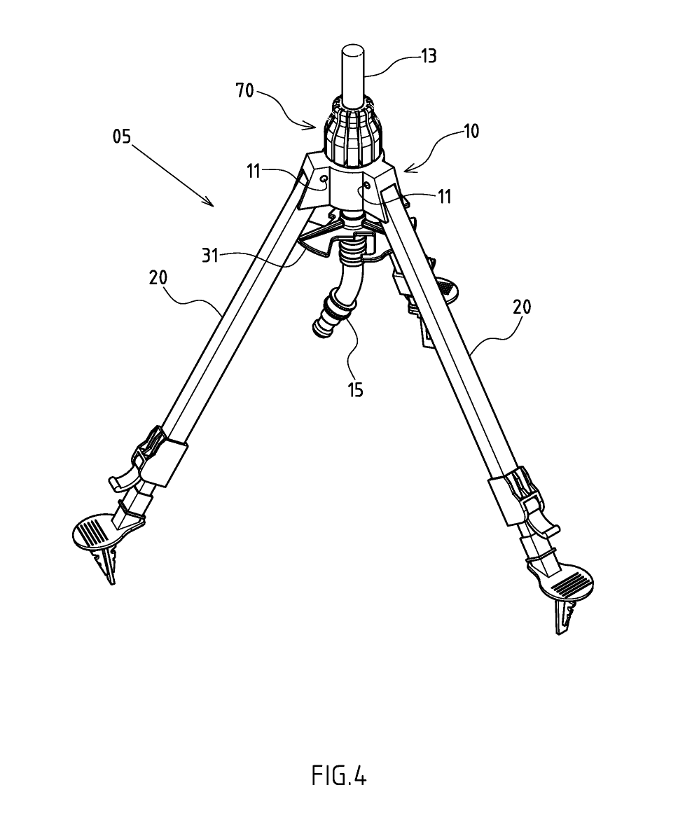

Said retaining plate 30 comprises of a sleeving portion 301, arranged at a preset location of the retaining plate 30; with the sleeving portion 301, said retaining plate 30 could be set on the water manifold 13 to rotate by taking the water manifold 13 as its axle center. Multiple abutting portions 31 are formed onto periphery of the retaining plate 30. When the foot stands 20 of the sprinkler tripod 05 are in expanded state, the retaining plate 30 is rotated such that the abutting portions 31 are mated with the foot stands 20, and the foot stands 20 can be abutted onto the abutting portions 31 for secure support (in collaboration with FIGS. 1, 4); during the sprinkling process of the sprinkler 14, this could prevent inward retracting, inclination or even fall down arising from vibration or shaking of the foot stands 20. Multiple openings 32 are set at one side of the abutting portions 31 of the retaining plate 30. When the foot stands 20 are in retracted state, the retaining plate 30 could be rotated such that the foot stands 20 can be inserted correspondingly into the openings 32 to create desired aesthetic effect for the foot stands 20.

Based on above-specified structure and the mating relationship of the abutting portions 31/openings 32 of the retaining plate 30 and the foot stands 20 of the sprinkler tripod 05, the foot stand 20 in expanded state could be securely supported, thus ensuring stable and secure sprinkling of the sprinkler 14 while avoiding inward retracting, inclination or even fall down arising from vibration or shaking of the foot stands 20. On the other hand, as the foot stands 20 in retracted state could be inserted into the openings 32, the foot stands 20 could swing uniformly and orderly with good visual effect and better convenience. Specifically, with the help of the retaining plate 30, the present invention allows to improve greatly the robustness of the sprinkler tripod 05 in expanded state and the aesthetic effect and convenience in retracted state as well as the actual benefits. In addition, said retaining plate 30 could be marketed in combination with the sprinkler tripod 05, or separately as spare parts, which shall be covered in the scope of the present invention.

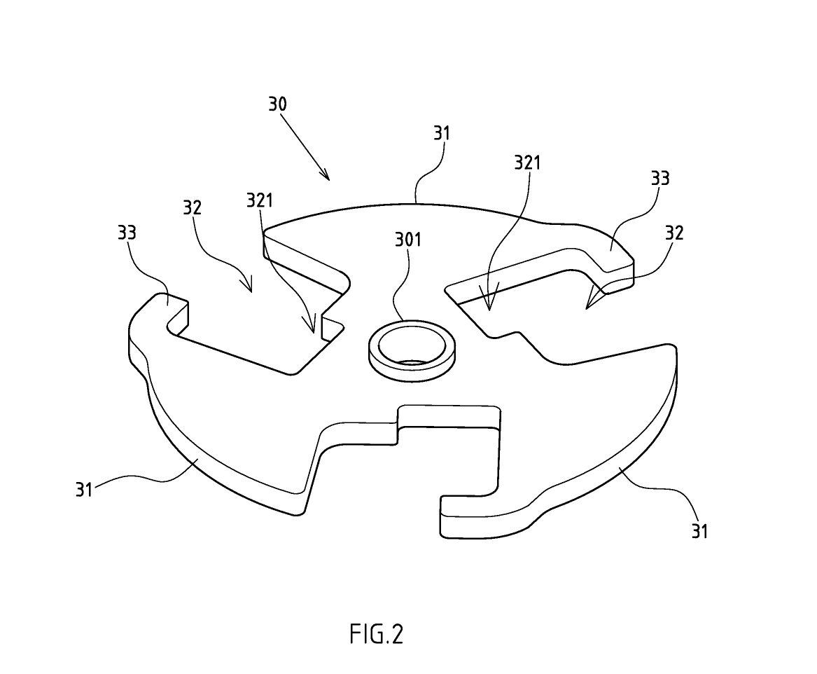

Referring to FIG. 1, the sleeving portion 301 is set at the center of the retaining plate 30 in a C-shaped clamping tube pattern. With this design, the retaining plate 30 could be sleeved onto the water manifold 13 more stably. Of which, a cutting slot 41 is arranged at a preset location of said sleeving portion 301. The cutting slot 41 could increase the flexibility of the sleeving portion 301 in expanded state. Moreover, at least one side of the retaining plate 30 is fitted with reinforced ribs 60 of preset shapes to increase the structural strength of the retaining plate 30. Or, referring to FIG. 2, the sleeving portion 301 is set at the center of the retaining plate 30 in an annular pattern.

Referring also to FIGS. 1 and 2, limiting flanges 33 are set at the openings 32 of the retaining plate 30. When the foot stands 20 are set at the openings 32, the retaining plate 30 is rotated such that the limiting flanges 33 could limit the foot stands 20 to prevent random swinging or expansion of the foot stands 20.

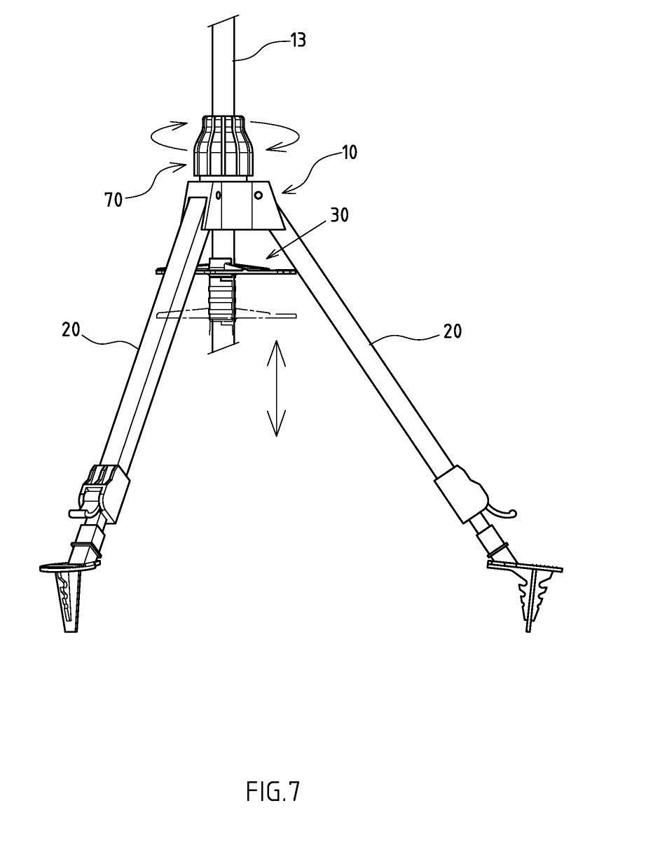

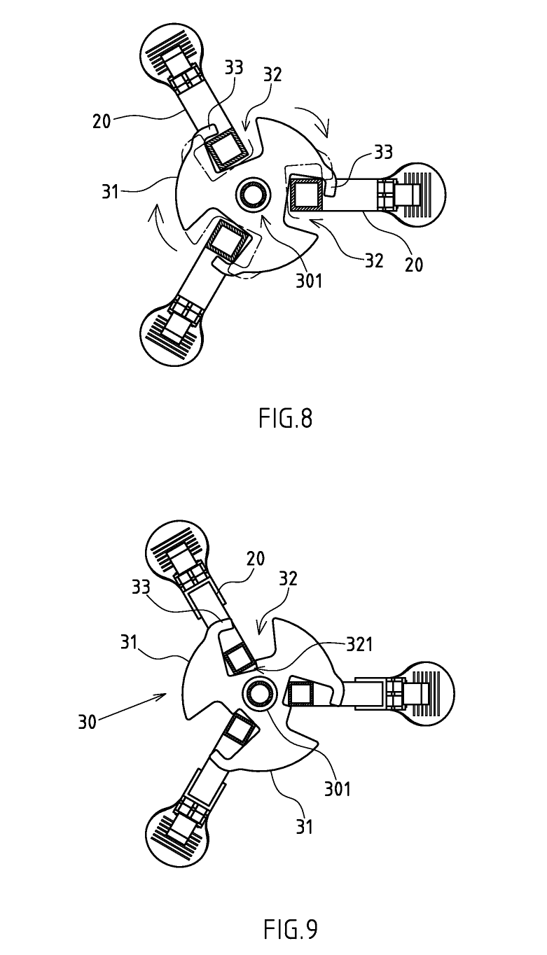

Referring to FIG. 7, the water manifold 13 could shift axially along the pedestal 10 in an adjustable state. Moreover, an adjustable spacer 70 is set at one end of the pedestal 10. Said adjustable spacer 70 could cooperatively limit the water manifold 13, and users can adjust the adjustable spacer 70 to compress or release the water manifold 13 (in this preferred embodiment, the adjustable spacer 70 is rotated to compress or release the water manifold 13).

Referring also to FIGS. 1 and 9, a limiting space 321 is set into the openings 32 of the retaining plate 30 facing the water manifold 13. The sectional area of the limiting space 321 must be smaller than the openings 32, such that the limiting space 321 permits to accommodate and limit the foot stands 20 of smaller diameter, and the openings 32 permit to accommodate and limit the foot stands 20 of bigger diameter for improved convenience and applicability.

1. A retaining plate, set onto a water manifold of the sprinkler tripod in a preset plate pattern, and located at interior of the foot stands of the sprinkler tripod; said retaining plate comprising:
a sleeving portion, arranged at a preset location of the retaining plate; with the sleeving portion, said retaining plate could be set on the water manifold to rotate by taking the water manifold as its axle center;
multiple abutting portions, formed onto periphery of the retaining plate; when the foot stands of the sprinkler tripod are in expanded state, the retaining plate is rotated such that the abutting portions are mated with the foot stands, and the foot stands can be abutted onto the abutting portions for secure support;
multiple openings, set at one side of the abutting portions of the retaining plate; when the foot stands are in retracted state, the retaining plate could be rotated such that the foot stands can be inserted correspondingly into the openings to create desired aesthetic effect for the foot stands.

2. The device defined in claim 1, wherein said sleeving portion is set at the center of the retaining plate in a C-shaped clamping tube pattern.

3. The device defined in claim 2, wherein a cutting slot is arranged at a preset location of said sleeving portion to increase the flexibility of the sleeving portion in expanded state.

4. The device defined in claim 1, wherein said sleeving portion is set at the center of the retaining plate in an annular pattern.

5. The device defined in claim 1, wherein limiting flanges are set at the openings of the retaining plate; when the foot stands are set at the openings, the retaining plate is rotated such that the limiting flanges could limit the foot stands.

6. The device defined in claim 5, wherein a limiting space is set into the openings of the retaining plate facing the water manifold; and the sectional area of the limiting space must be smaller than the openings, such that the limiting space permits to accommodate and limit the foot stands of smaller diameter, and the openings permit to accommodate and limit the foot stands of bigger diameter.

7. The device defined in claim 5, wherein at least one side of the retaining plate is fitted with reinforced ribs of preset shapes to increase the structural strength of the retaining plate.

8. A sprinkler tripod comprising:
a pedestal, set into a predefined pattern of actual model; multiple pin joints are arranged at interval on the circumferential sections of the pedestal; and a through hole is vertically set at the center of the pedestal for insertion of a water manifold; a sprinkler is set above the water manifold, and a mating portion is set below the water manifold for water supply; multiple foot stands, one end of which is separately pivoted at the pin joint of the pedestal, such that the foot stands could swing by taking the pin joint as axle center in an expandable or retractable state;
a retaining plate, set onto the water manifold in a preset plate pattern below the pedestal; and said retaining plate must be located at interior of the foot stands; said retaining plate comprises of:
a sleeving portion, arranged at a preset location of the retaining plate; with the sleeving portion, said retaining plate could be set on the water manifold to rotate by taking the water manifold as its axle center,
multiple abutting portions, formed onto periphery of the retaining plate; when the foot stands of the sprinkler tripod are in expanded state, the retaining plate is rotated such that the abutting portions are mated with the foot stands, and the foot stands can be abutted onto the abutting portions for secure support;
multiple openings, set at one side of the abutting portions of the retaining plate; when the foot stands are in retracted state, the retaining plate could be rotated such that the foot stands can be inserted correspondingly into the openings to create desired aesthetic effect for the foot stands.

9. The device defined in claim 8, wherein said sleeving portion is set at the center of the retaining plate in a C-shaped clamping tube pattern.

10. The device defined in claim 9, wherein a cutting slot is arranged at a preset location of said sleeving portion to increase the flexibility of the sleeving portion in expanded state.

11. The device defined in claim 8, wherein said sleeving portion is set at the center of the retaining plate in an annular pattern.

12. The device defined in claim 8, wherein limiting flanges are set at the openings of the retaining plate; when the foot stands are set at the openings, the retaining plate is rotated such that the limiting flanges could limit the foot stands.

13. The device defined in claim 12, wherein a limiting space is set into the openings of the retaining plate facing the water manifold; and the sectional area of the limiting space must be smaller than the openings, such that the limiting space permits to accommodate and limit the foot stands of smaller diameter, and the openings permit to accommodate and limit the foot stands of bigger diameter.

14. The device defined in claim 12, wherein at least one side of the retaining plate is fitted with reinforced ribs of preset shapes to increase the structural strength of the retaining plate.

15. The device defined in claim 12, wherein said water manifold could shift axially along the pedestal in an adjustable state; moreover, an adjustable spacer is set at one end of the pedestal; said adjustable spacer could cooperatively limit the water manifold, and users can adjust the adjustable spacer to compress or release the water manifold.
